(19) United States
(12) Patent Application Publication
(10) Pub. No.: US 2009/0043791 A1
(43) Pub. Date: Feb. 12, 2009

(54) Method, Computer System and Computer Program for Processing a Structured Data Record

(75) Inventor: Armin Fricke, Kleinmachnow (DE)

Correspondence Address: THE WEBB LAW FIRM, P.C., 700 KOPPERS BUILDING, 436 SEVENTH AVENUE, PITTSBURGH, PA, 15219, US

(73) Assignee: TECHNISCHE FACHHOCHSCHULE WILDAU, Wildau (DE)

(21) Appl. No.: 12/282,224

(22) PCT Filed: Mar. 8, 2007
(86) PCT No.: PCT/EP2007/002179

§ 371 Date: Oct. 28, 2008

(30) Foreign Application Priority Data
Mar. 10, 2006 (EP) 06090033.9

(51) Int. Cl. G06F 17/30

(52) U.S. Cl. 707/100; 707/E17.046

(57) ABSTRACT

Disclosed is a computer system for processing a structured data record, said system having a communication device for retrieving and sending the structured data record, a database device for storing the structured data record and an analysis device for processing the structured data record. The structured data record contains a number of characteristic information items. The analysis device has means for automatically analyzing the characteristic information items contained in the structured data record, means for automatically classifying the structured data record, which means can be used to organize the structured data record into a class using the characteristic information items, and means for automatically evaluating the structured data record which has been organized into a class, which means can be used to link the structured data record to other structured data records in the same or different classes using the characteristic information items.

The invention relates to a computer system for processing a structured data record in accordance with the preamble of claim 1, to a method for processing a structured data record in accordance with the preamble of claim 9 and to a computer program for carrying out the method.

Such a computer system has a communication device for retrieving and sending a structured data record, a database device for storing the structured data record and an analysis device for processing the structured data record. For this purpose, the computer system may comprise an e-mail server, an FTP server or another data server, for example, which is used to receive the structured data records electronically from a further computer system so that they can be processed further. In this case, the communication between the various computer systems is effected in a known manner via telecommunication networks, for example the Internet, by interchanging structured data records which contain characteristic information items arranged in an arbitrary, nonstandardized manner in the structured data record. Such data records are also referred to as structured, nonstandardized data records. Structured data records in this sense may be e-mails or any other electronic files which are interchanged via the Internet for the purpose of communication between computer systems, for example.

The interchange of structured data records for the purpose of communication is playing an ever greater part in a very wide variety of areas of public life. The interchange of such data records allows particular processes to be described, controlled and regulated. A process in this context refers to a process which comprises a plurality of process steps and which involves the interchange of structured data records. In particular, such a process may be a business process, a communication process, a regulation process or a manufacturing or production process. The characteristic information items contained in the structured data records may then be parameters which, by way of example, describe the process or are used to control the process.

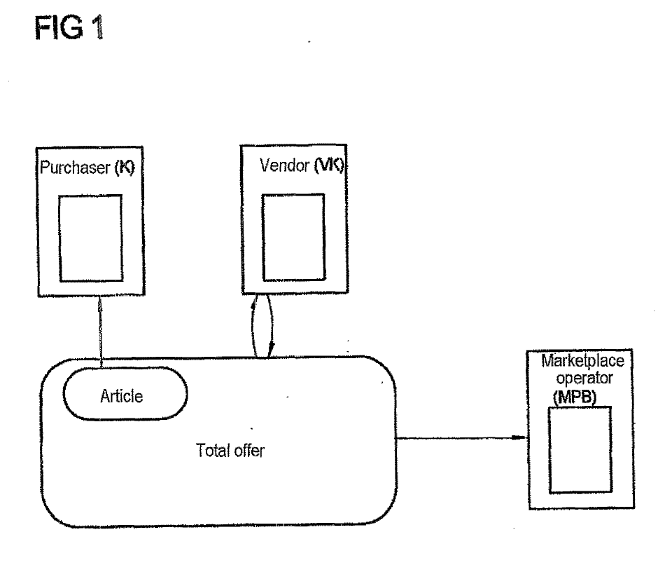

Such a process will be illustrated by way of example below with reference to the communication at electronic marketplaces, the basic scenario for which is shown in FIG. 1. In a transaction at an electronic marketplace operated by a marketplace operator MPB, a vendor VK offers an article via the electronic marketplace. An interested party I can retrieve and pick up this offer via an electronic network and therefore becomes the purchaser K. The three-party communication between the vendor VK, the purchaser K and the marketplace operator MPB (who are referred to in summary as marketplace participants MPT) takes place automatically in this case through the interchange of structured data records.

The communication between the MPTs traditionally involves the use of standardized communication protocols, such as Electronic Data Interchange (EDT) or eXtensible Markup Language (XML). EDI is the interchange of electronic data between various computer systems via an electronic transmission medium based on a format which is understood by all participants. EDI forms the basis for numerous substandards, such as UN/EDIFACT (United Nations Electronic Data Interchange For Administration, Commerce, Transport), SWIFT (Society for worldwide Interbank Financial Telecommunications) and ODETTE (Organization for Data Exchange Through Teletransmission in Europe). XML provides a standard for the definition of general data structures and for the presentation of instances of the data structures. However, XML is only an interchange format and is not a standard at application level. XML has been taken as a basis for deriving numerous languages for communication between applications, such as Simple Object Access Protocol (SOAP) or ebXML for the development of an XML-based frame for B2B e-commerce (business to business electronic commerce).

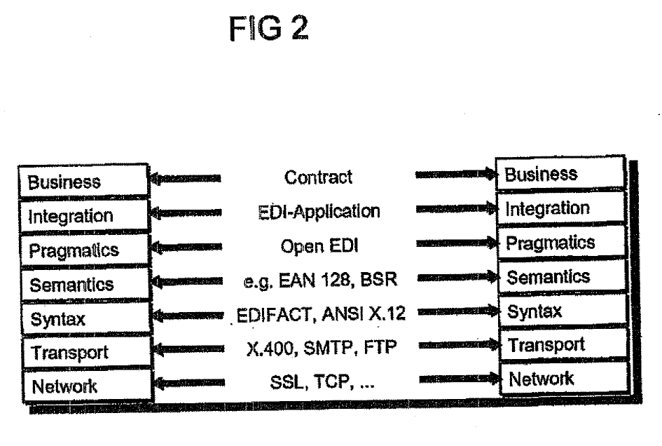

The implementation of said and other (not mentioned here) standards and languages in application programs of the MPTs can take place at different levels of a solution for processing electronic data in the form of structured data records. The existing standards relating to the various levels of the communication are shown by way of example and schematically in FIG. 2. In this case, levels are understood to mean the technical (Network, Transport) and content-related (Syntax, Semantics, Pragmatics, Integration, Business) aspects which define the communication. As can be seen from FIG. 2, an application based on EDI allows standardized-content communication at the “Integration” level, whereas an application based on the more recent standards XML or SOAP or ebXML allows standardized-content communication between the MPTs on the “Business” level. In this case, existing systems communicate using structured standardized data records which contain characteristic information items at defined positions and which are used to standardize the communication and data interchange between the MPTs. The implementation is complex and is usually effected as part of comprehensive communication systems. These communication systems are therefore used exclusively by commercial MPTs, who wish to communicate automatically (firstly) on the basis of their order volume or their frequency of order with (secondly) a fixed group of customers. These standards are unsuitable and are not used for use in transactions with end customers (B2C: business to consumer) or with small commercial customers (B2B: business to business) (jointly referred to as “small customers”) which do not have comprehensive communication systems available or with whom there is no constant relationship.

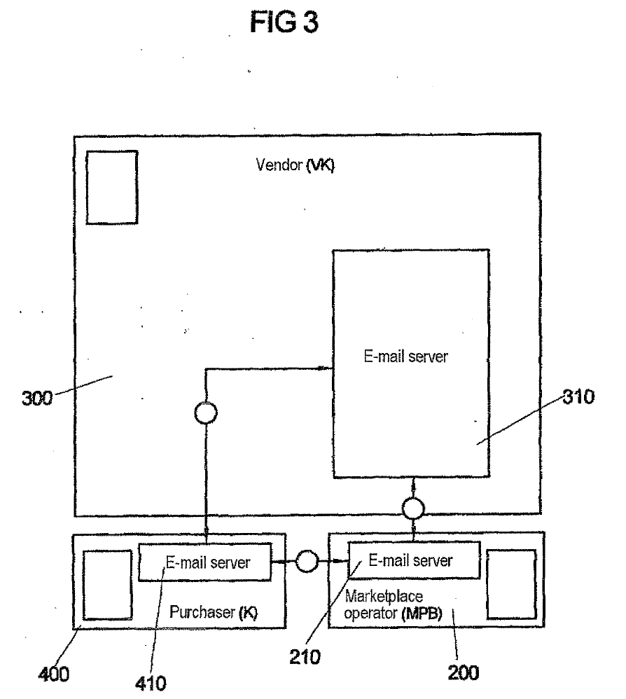

MPTs who cannot use such communication systems for communication using standardized structured data records for financial reasons can use only nonstandardized structured data records, for example in the form of e-mails (in line with the “SMTP” protocol on the “Transport” level in FIG. 2). The MTPs in today's electronic marketplaces for private end customers (B2C) and small commercial customers (B2B) therefore communicate largely by interchanging nonstandardized data records, for example by e-mail using the protocols (standardized at transport level and therefore structured) SMTP (for sending the structured data records) and POP3 or IMAP4 (for receiving the structured data records), via what are known as e-mail servers, as shown schematically in FIG. 3.

The above illustration of a process with reference to a selling process at an electronic marketplace has been chosen mainly by way of example here. In principle, this may relate to all processes in which communication is effected by interchanging nonstandardized structured data records, that is to say that the communication is not standardized. By way of example, such processes using nonstandardized structured data records may also be relevant for a production line within a production process, particularly for automated production at physically separate locations with different process participants.

A drawback of communication between computer systems using nonstandardized structured data records is that conventionally an integrated, overall view of the respective processes described by the structured data records is not possible. In this case, the processes are usually characterized in that they are executed asynchronously and may contain multiple branches, with a multiplicity of data records interchanged between computer systems possibly resulting in considerable demands on the computer systems used, particularly in terms of memory space requirement and computation power. Automatic and efficient archiving of the data records interchanged within a process is not possible. Since the communication is not standardized, the processes also usually cannot be measured, that is to say cannot be compared with particular standard values, and therefore cannot be automated. It follows from this that automatic adaptation of the processes (“self-learning systems”) for optimization purposes is not possible.

A fundamental problem with such processes executed in nonstandardized fashion is therefore that the processes are slow and inefficient, place great demands on the computer systems used, particularly in terms of their memory space, and are also susceptible to error on account of the human interaction which is required owing to the lack of automatability.

The object on which the present invention is based is to provide a method, a computer system and a computer program which can be used to make it possible to measure processes which are based on the interchange of nonstandardized structured data records in order to allow such processes to be optimized and automated.

This object is achieved by a subject matter having the features of claim 1.

In this case, the invention provides for a computer system for processing a structured data record, having
a communication device for retrieving and sending the structured data record,
a database device for storing the structured data record,
an analysis device for processing the structured data record,
   wherein the structured data record contains a number of characteristic information items arranged in an arbitrary manner in the structured data record, to be characterized
   in that the analysis device has
means for automatically analyzing the characteristic information items contained in the structured data record,
means for automatically classifying the structured data record, which are able to be used to classify the structured data record into a class using the characteristic information items, and
means for automatically evaluating the structured data record classified into a class, which are able to be used to link the structured data record to other structured data records in the same or other classes using the characteristic information items.

The computer system according to the invention therefore provides an apparatus which can be used to process structured data records containing characteristic information items arranged in an arbitrary, nonstandardized manner. In this context, characteristic information items may be all information and parameters which describe a process, control a process and/or are associated with a process in another way. In the case of a selling process, these may particularly be details about an article sold, a purchaser, a vendor, the process duration, the start of the process, the end of the process, payment terms, associated other processes or other information relating to the process. A production process may accordingly involve details about the process duration, the start of the process, the end of the process, technical process parameters (measured values describing the process, functional parameters, etc.), number of items, machine information (type of machine, machine states, error information) and the like. The essential matter in this case is that a process involves the interchange of structured data records with characteristic information items as part of a process, the nature of the process in itself being insignificant.

The invention achieves the underlying object, namely rendering a nonstandardized process measurable, by virtue of the analysis device reading and hence automatically recording the characteristic information items contained in an arbitrary manner in the structured data record, using the characteristic information items to classify the structured data record into a class and linking the structured data record classified into a class to other structured data records in the same or other classes. The computer system's analysis device therefore reads the characteristic information items distributed in the structured data record and processes the structured data record automatically. In this case, the structured data record is assigned to a class, a class being able to describe a process step in a process, so that the structured data record is sorted into the framework of a process by the association with a class. In a selling process, these classes may have been overwritten by “buying”, “selling”, “paying”, “sending”, “complaint” or the like, for example, and may comprise structured data records which are associated with the class classified in this manner. In a production process, the classes may accordingly be formed by the process steps “assembly”, “testing”, “final acceptance”, for example, but also in a finer breakdown by the steps “connection of two parts”, “setting of a weld joint”, “formation of a contact”, or the like.

A fundamental aspect of the invention is that the characteristic information items arranged in an arbitrary, undefined and nonstandardized manner in the data record are evaluated automatically and the structured data record is processed further using these characteristic information items by virtue of its being assigned to a class and linked to other structured data records. This allows processes involving the structured data records being interchanged to be described and particularly to be represented as a whole by virtue of the linking of the structured data records connecting and hence illustrating the process steps represented by the structured data records.

A fundamental advantage of the invention is that processes of any kind can be recorded and automatically represented by means of the computer system according to the invention and the processes are therefore rendered measurable. This allows processes to be automatically evaluated, analyzed and optimized. In particular, it is possible to use the computer system according to the invention to make process cycles more efficient, to speed them up and to optimize them in terms of their execution and their technical requirements, for example memory space requirement and computation power.

In this case, the computer system may be an interface which is arranged for the purpose of evaluating structured data records between a second computer system, from which a structured data record or a set of structured data records is retrieved, and a third computer system, to which the linked structured data records together with evaluated information describing a process are transmitted. In this case, the computer system acts as a connecting medium between the further computer systems, wherein the computer system evaluates and assesses the structured data records interchanged between the further computer systems, which data records contain characteristic information items in an arbitrary arrangement which is respectively unknown to the other computer system, and makes the characteristic information items contained in the structured data records available to one or both of the further computer systems. In this case, the computer system is an entity between the further computer systems which automatically evaluates the structured data records interchanged between the further computer systems for the purpose of communication. A fundamental advantage in this case is that the third computer system does not merely receive a structured data record, but rather the computer system makes the evaluated information about the process affected by the structured data record and the relevant characteristic information items relating to the process available to it.

The computer system's communication device which electronically interchanges the structured data records with the further computer systems may be an e-mail server, an FTP server or another device for transmitting electronic data, for example. In this case, the communication device sets up the communication with the further computer systems automatically and electronically.

Preferably, the computer system's analysis device has means for evaluating the linked structured data records, which means are used to analyze the data structure obtained by linking the structured data records and to assign it to a process, for example, so that the linking of the structured data records can be used to identify a process. In this case, it is assumed that every structured data record which is processed by the computer system is associated with a process step in a process and the process can be mapped as a whole by the linking of the structured data records.

Advantageously, the computer system furthermore has an output unit for presenting the linked structured data records, which output unit can be used to map a process described by the linked structured data records, for example.

In particular, the output unit may be formed by a web server which is used to make the recorded characteristic information items and the information about a process which has been ascertained by the linking of the structured data records available to a user electronically via an information network, in this case the Internet.

In addition, the computer system may have a notification system for notifying a user when an error ascertained using the linked structured data records occurs in a process represented by the linked structured data records. In particular, when the structured data records which represent a process and which are linked to one another by the analysis device are used to establish that an error has occurred within the process, for example because a process step has not been performed or has been performed only incompletely or late, this error can be indicated to a user immediately via the notification system and the user can therefore be advised of malfunctions in the process at an early stage. Action by the user can then either immediately redress the error in the process or—if an error threat is identified at an early stage—immediately counteract this error.

In this connection, the notification system may be formed by a telecommunication device for communication with a user, for example, the telecommunication device interacting with a further, particularly mobile, telecommunication device of the user, for example. The notification system can automatically notify the user, for example, via his mobile telephone by producing a text message in the form of an SMS and sending it to the user.

The object is furthermore achieved by a method for processing a structured data record having the features of claim 9.

In this case, the invention provides for a method for processing a structured data record, using a computer system as claimed in one of claims 1 to 8, in which the structured data record is retrieved, stored and processed, wherein the structured data record contains a number of characteristic information items arranged in an arbitrary manner in the structured data record, to be characterized in that
the characteristic information items contained in the structured data record are recorded automatically,
the structured data record is automatically assigned to a class using the characteristic information items, and
the structured data record is automatically linked to other structured data records using the characteristic information items.

The method according to the invention therefore provides the option of automatically analyzing and processing structured data records which contain characteristic information items arranged in an arbitrary, nonstandardized manner. Specifically, this involves the characteristic information items contained in an unknown manner in the structured data record being ascertained and on the basis of these characteristic information items the structured data record then being assigned to a class and being linked to other structured data records. Usually, there is no prior knowledge either of what characteristic information items the structured data records contain or of the manner in which the characteristic information items are arranged in the structured data records. First, the method therefore involves recording what characteristic information items have been transmitted with the structured data record and what significance and/or value these characteristic information items have. These characteristic information items are then automatically used to assign the structured data record to a class, with a class in this case being able to represent a process step in a process. By virtue of the structured data record associated with a class then being linked to other structured data records, the process, which is defined by individual process steps, can then be represented as a whole and can be described and measured using the characteristic information items contained in the structured data records.

In this case, the structured data record processed in the method may have, in particular, a standardized structured part, which contains characteristic information items in a defined arrangement, and a nonstandardized structured part, which contains characteristic information items in an arbitrary arrangement.

The method involves the structured data record then advantageously first of all being broken down into its standardized structured part and its nonstandardized structured part for the purpose of recording the characteristic information items contained in the structured data record.

The characteristic information items contained in the structured data record are then recorded by virtue of the standardized structured part and the nonstandardized structured part of the structured data record being evaluated separately. When there are a multiplicity of structured data records used for the electronic communication, such division into a standardized structured part and a nonstandardized structured part is provided. In this connection, the standardized structured part is also called a “header”, while the nonstandardized structured part is called a “body”. The method is then used to automatically evaluate the characteristic information items which are contained both in the standardized structured part and in the nonstandardized structured part of the structured data record, the arrangement of the characteristic information items in the standardized structured part being known in advance, whereas the structure of the nonstandardized structured part is not known in advance and is therefore ascertained only as part of the evaluation.

As already explained above, the method involves the structured data record being automatically assigned to a class, which characterizes a process step in a process, using the characteristic information items contained in the structured data record. In this case, the basic idea is that the structured data records are part of a process which forms a communication process and are respectively assigned to one or more process steps. The process steps can be classified into classes and are described by the classes.

The method involves the structured data records which are associated with a class being linked to other structured data records. By linking the structured data records, this can result in a cohesive data record structure in the form of a chain, which may be in a linear or else branched form.

The linked structured data records then represent a process which comprises one or more process steps and whose linking and execution can be mapped by the linking of the structured data records.

The linked structured data records and the characteristic information items contained in the structured data records can therefore now be used to identify the process described by the linked structured data records by inferring the underlying process from the map produced by the linking.

Furthermore, it is possible to evaluate the process described by the linked structured data records and, as part of the evaluation, to record all the information which describes the process and is connected to the process.

On the basis of the evaluation of the process, the linked structured data records forming the process can then be stored, erased and/or processed further. In this case, the process is evaluated automatically, with the evaluation of the process establishing what measures are necessary or expedient for processing the structured data records. By way of example, this allows automatic archiving of all the structured data records describing a process and hence efficient memory management.

In addition, the linked structured data records and the characteristic information items contained in the structured data records, which characteristic information items have been recorded automatically by the evaluation of the structured data records, can be used to compare the process described by the structured data records with previously defined standard values. By analyzing and evaluating the process, the process per se can therefore be measured and can be rated by means of the comparison with particular standard values.

In particular, this means that by evaluating the process using the linked structured data records, a process step to be performed subsequently can be automatically identified, so that the process can be continued automatically. The method then first of all involves the processed structured data records being used to identify a process and at the same time the status of the process and a resultant measure to be performed being recorded, said measure then being able to be prompted automatically.

In addition, it is possible to use the linked structured data records and the characteristic information items contained in the structured data records to optimize the process described by the structured data records in terms of at least one optimization criterion. The idea in this case is that the analysis of the structured data records, which describe the process as a whole, ascertains weaknesses in the process, for example delay times or inaccuracies in the process or in individual process steps, to which it is then possible to react automatically.

The optimization criteria which can be used to optimize a process in this case may be the process duration, the process speed and/or the process cycle, for example. It is also conceivable for individual process steps to be optimized in a specific manner using the characteristic information items recorded from the structured data records, so as thereby to achieve optimization of the entire process through optimization of a process step.

In this connection, it is also conceivable for the linked structured data records to be used to ascertain errors or peculiarities in a process which are then immediately indicated to a user so as to advise him of incorrect behavior in the process. Such an error may be in an individual process step or in the sequence of the process steps, for example, and may therefore affect an individual process step or the entire process.

The method according to the invention makes it possible to measure processes which are determined and can be described by the interchange of structured data records. The evaluation of the processes then allows both analysis of an individual process in terms of its specific features relating to this specific process or evaluation of a multiplicity of processes in terms of their statistical features describing all of the processes. The fact that the processes per se are rendered measurable therefore means that the processes can be evaluated completely both in the specific and in the general, statistical sense.

The method involves the processing of structured data records which contain characteristic information in an arbitrary, nonstandardized arrangement. The method respectively records whether and in what manner the characteristic information items are stored in the structured data records. In this case, it is conceivable for the method to involve the structure of a structured data record being recorded and stored and, if a structured data record with the same structure is received, the structured data record being analyzed efficiently using the stored structure. The method therefore allows the previously unknown structures of structured data records to be learnt in order to allow efficient processing of the structured data records when comparable structured data records occur again.

It is also conceivable for classes which describe process steps to be freshly learnt. In particular, this may involve a structured data record which cannot be assigned to a class being automatically assigned to a freshly generated class and the class freshly generated in this manner being stored.

Similarly, a previously unknown process can also be freshly learnt in this manner by automatically assigning the linked structured data records which cannot be clearly assigned to a process to a freshly generated process. In this case, it is expedient for a user to be automatically notified of a piece of information about freshly generated classes and/or freshly generated processes.

The object is furthermore achieved by a computer program for processing a structured data record from a set of structured data records for the purpose of carrying out the method as claimed in one of claims 9 to 28, wherein the method steps described in claims 9 to 28 are implemented within the computer program and are executed on a computer system.

The idea on which the invention is based will be explained in more detail below with reference to the exemplary embodiments illustrated in the figures, in which:

FIG. 1 shows a schematic illustration of a scenario describing an electronic marketplace;

FIG. 2 shows a schematic illustration of various standards for communication at different levels;

FIG. 3 shows a schematic illustration of the communication between participants in an electronic marketplace;

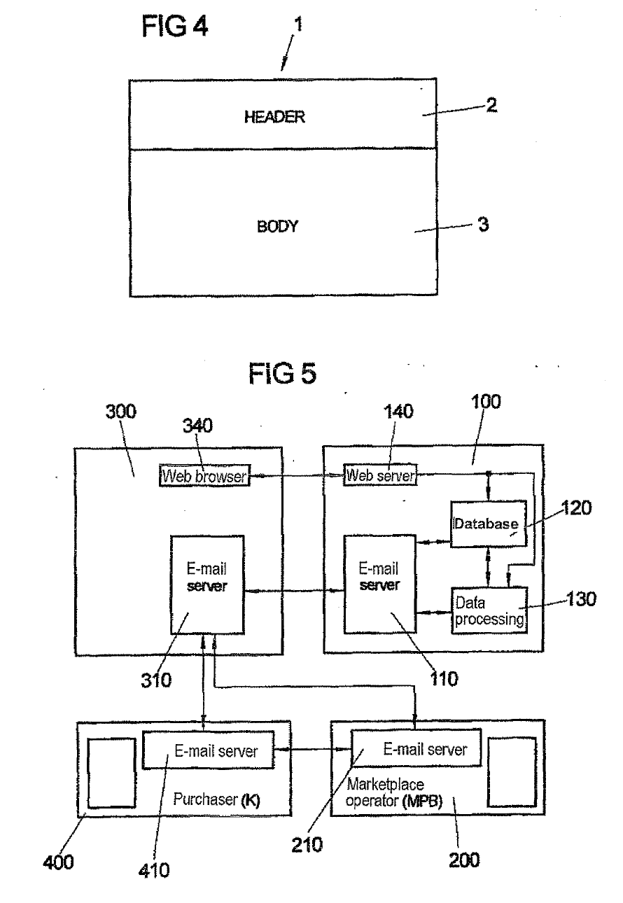

FIG. 4 shows a schematic illustration of a structured data record with a standardized structured part and a nonstandardized structured part;

FIG. 5 shows a schematic illustration of a computer system implementing the invention for communication with further computer systems;

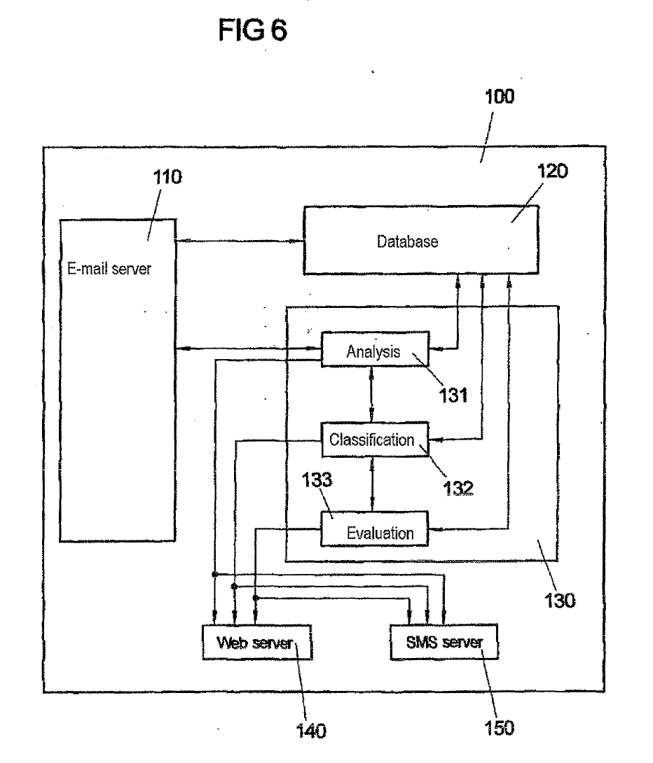

FIG. 6 shows a schematic detail illustration of a computer system implementing the invention, and

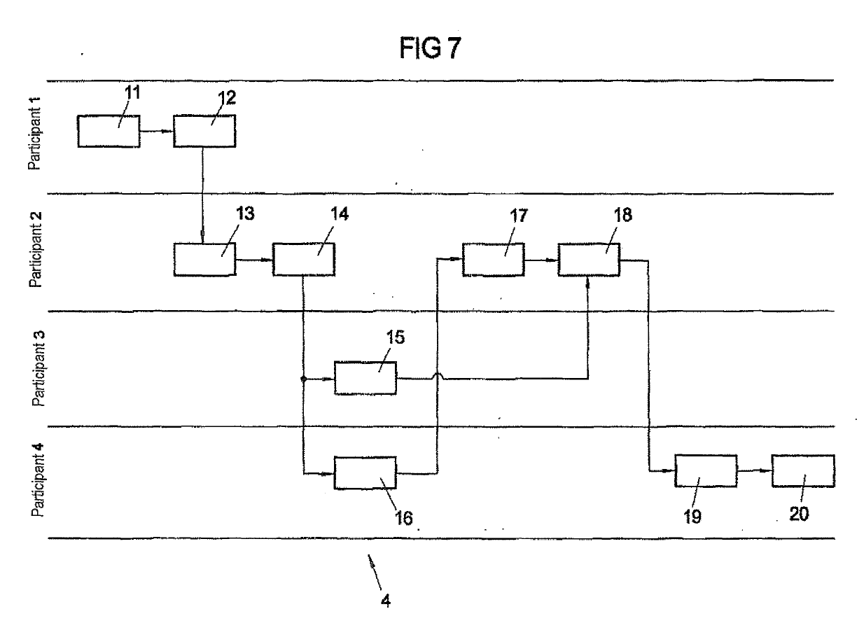

FIG. 7 shows a schematic illustration of a process described by linked structured data records.

A basic scenario describing the communication between three participants by way of example is shown in FIG. 3 and schematically shows the communication between a vendor VK, a purchaser K and a marketplace operator MTB at an electronic marketplace. The vendor VK, the purchaser K and the marketplace operator MTB respectively use a computer system 200, 300, 400 which has a respective e-mail server 210, 310, 410 which is used to handle the communication between the vendor VK, the purchaser K and the marketplace operator MTB for the interchange of structured data records. In this case, the computer systems 200, 300, 400 are used to send structured data records from one e-mail server 210, 310, 410 to another e-mail server 210, 310, 410 and hence to interchange data between the computer systems 200, 300, 400 and to handle processes. In this connection, the e-mail servers 210, 310, 410 are communication devices and may also be formed by an FTP server or other apparatuses for interchanging electronic data for example.

Although the basic scenario in FIG. 3 shows the communication within the framework of an electronic marketplace, this merely serves for illustration without limiting the general nature. By way of example, a similar scenario may also describe the communication within the framework of a production process, with the involvement of various machines, installations and apparatuses, the computer systems 200, 300, 400 respectively being connected for control purposes to an installation or a machine and the production process per se being controlled by the communication between the computer systems 200, 300, 400.

The invention relates to a computer system, a method and a computer program for processing structured data records which are interchanged within the framework of a process and therefore represent the fundamental content of the process. The structure of such a structured data record is shown by way of example in FIG. 4. In this case, the structured data record 1 has a standardized structured part 2, what is known as the header, and a nonstandardized structured part 3, what is known as the body. The standardized structured part 2 stores characteristic information items in a defined manner stipulated by a standard (for example the standard on which the SMTP protocol is based) and contains them in a defined arrangement. The nonstandardized structured part 3, on the other hand, contains characteristic information items in a previously unknown, arbitrary arrangement, so that it is not known in advance whether a particular characteristic information item is contained in the structured data record 1 and, if the characteristic information item is contained in the structured data record 1, at what location it can be found in the nonstandardized structured part 3 of the structured data record 1. In this case, the characteristic information items may include all information describing a process and relevant to a process. By way of example, such characteristic information items in the case of a selling process may be details about the purchaser, the vendor, the article, the payment terms, the delivery terms, the contractual terms, the purchase time, the delivery time, any complexities or complications in the process and the like. In the case of a production process, the characteristic information items may, in particular, be information about production terms, production progress, production parameters, the status of individual production steps, machine parameters and states and the like. Ultimately, the characteristic information items include all information which describes a process and/or is associated with a process in any way.

FIG. 5 shows an exemplary embodiment of the computer system 100 according to the invention, said computer system 300 interacting with the computer system 300 of a user by receiving structured data records 1 from the computer system 300, evaluating them and returning the evaluated structured data records 1 together with the recorded information to the computer system. Furthermore, a schematic detail view of the computer system 100 is shown in FIG. 6. The computer system according to the invention has a communication device in the form of an e-mail server 110, a database device in the form of a database 120, an analysis device in the form of a data processing unit 130 and an output unit in the form of a web server 140. In addition, as FIG. 6 shows, the computer system 100 may contain a notification system in the form of an SMS server 150. In this case, the analysis device 130 specifically has means 131 for analyzing a structured data record 1, means 132 for classifying the structured data record 1, and means 133 for evaluating the structured data record 1.

The cycle which the computer system 100 carries out in order to evaluate a structured data record 1 takes place as follows: during a process, the computer systems 200, 300, 400 interchange structured data records 1. In this case, as explained above, the structured data records 1 can perform a selling process or control a production process for example. The computer system 100 implementing the invention is connected to the computer system 300 and uses its communication device in the form of the e-mail server 110 to retrieve structured data records 1 from the communication device in the form of the e-mail server 310 of the computer system 300. In principle, it is also conceivable for the computer system 100 to be connected to the computer systems 200, 400 of the other participants, so that in this case the structured data records 1 would be retrieved from the e-mail servers 210, 410 directly or any communication at all, that is to say any interchange of structured data records 1, between the computer systems 200, 300, 400 could take place via the e-mail server 110 of the computer system 100.

The structured data records 1 retrieved by the e-mail server 110 are then stored in the database 120 and forwarded to the analysis device 130 for analysis, classification and evaluation. Specifically, each structured data record 1 is broken down into its standardized structured part 2 and its nonstandardized structured part 3, and then the characteristic information items respectively stored in the two parts 2, 3 are recorded and evaluated. Using the characteristic information items ascertained in this manner, the structured data record 1 is then assigned to a class, each class characterizing a process step. The classification into classes therefore stipulates that a structured data record 1 has been created as part of the performance of a particular process step and provides details relating to this particular process step. Within the framework of a production process, this may involve, by way of example, stipulating that a particular structured data record 1 is associated with a process step “connection of part A to part B” and contains information about this process step. Similarly, a selling process may involve ascertaining that the structured data record 1 provides details relating to a process step “delivery of the article”, for example.

Within the framework of the evaluation, each structured data record 1 is then linked to other structured data records, the linked structured data records forming a cohesive data structure and as a whole mapping a process completely. The linked structured data records can now be used to evaluate the process, to measure it and to compare it with defined standard values and hence to optimize it. By way of example, the process described by the linked structured data records can be analyzed in order to identify process steps which are susceptible to error or time-consuming, so as to specifically allow such process steps to be optimized. At the same time, the process can be evaluated as a whole and compared with other processes in order to obtain an overview of all the processes taking place. It is also possible to evaluate the processes in order to obtain information about processes taking place erroneously, missing process steps or threatening errors in a process, which can then be pointed out directly by means of the notification system in the form of the SMS server 150.

Furthermore, the results of the analysis, of the classification and of the evaluation of the structured data records 1 and of the information ascertained within the context of the linking can be made available to the computer system 300 of a user, who can retrieve and inspect these results using a web browser 340, via the web server 140 which forms the output unit.

An exemplary cycle for a process 4 which involves the interchange of structured data records 11-20 is shown in FIG. 7. This exemplary process 4 involves interchange of structured data records 11-20 between four participants (participant 1, participant 2, participant 3, participant 4), which may be participants in an electronic marketplace in line with the scenario shown in FIG. 3, for example, or else may be various computer systems in a production installation which control a machine. In this case, the process involved structured data records 11-20 being interchanged between the participants, wherein participant 1 sends structured data records 11, 12, for example, then participant 2 produces structured data records 13, 14, to which participant 3 and participant 4 react with structured data records 15, 16, for which participant 2 in turn creates structured data records 17, 18, to which participant 4 in turn responds with structured data records 19, 20. The computer system implementing the invention compiles the structured data records 11-20 using the characteristic information items contained in the structured data records 11-20, links the structured data records 11-20 to produce a cohesive data structure which can also be used to represent all the possible branches, and therefore maps an overall picture of the process 4. By forwarding the computer system according to the invention, it is possible in this case to record the process automatically and to automatically identify process steps to be performed subsequently, so that the process can take place automatically in full using the computer system. At the same time, automatic evaluation of the process 4 is possible, with the process being described completely by the characteristic information items contained in the structured data records 11-20 and being represented by the linking of the structured data records 11-20. In this case, the structured data records 11-20 are linked both by means of time-based linkage and by means of content-based linkage using the characteristic information items contained in the structured data records 11-20.

Often, the chronology is fundamental to a process. The linking of the structured data records allows this cycle to be represented and measured specifically, with the evaluation of the structured data records being used to ascertain the participants in the process, to identify the process steps and hence to analyze the process. In particular, the linking of the structured data records can therefore be used to identify existing processes and to ascertain and record previously unknown processes. In this case, the computer system used for implementation may be self-learning, so that the computer system automatically identifies and stores new processes and the volume of the known processes is increased dynamically.

The evaluation and linking of the structured data records therefore allows processes to be identified and optimized. In addition, automatic archiving of the structured data records using the evaluation of the processes is possible. If, by way of example, the evaluation is used to establish that a process has concluded, it is automatically possible to relocate all the structured data records connected to the process to an archive, so that efficient memory management is possible.

Applied to a selling process, for example for supporting and handling selling processes at electronic marketplaces, the method according to the invention and the computer system according to the invention can be used in similar fashion to what has been said above in order to map the processes taking place and to render them measurable. In particular, it therefore becomes possible for processes taking place to be evaluated completely and automatically by a dealer, said processes involving customer data being recorded, assessed and stored and the processes being able to be optimized and influenced using the customer data and evaluated in a specific manner to ascertain a customer value (for example by classifying the customers into “good” and “poor” customers using criteria such as payment soundness, trustworthiness and reliability). Equally, general, statistical evaluation of all of the processes taking place is also possible, for example in order to ascertain sales volumes, to record peaks in demand for particular articles, to identify delivery bottlenecks and to monitor suppliers.

A fundamental advantage of the subject matter according to the invention is that the evaluation can be performed totally automatically using the structured data records which are interchanged anyway as part of the process, and hence susceptibility to error can be reduced and the efficiency of the evaluation can be increased substantially. In many cases, the presented method, performed on the computer system according to the invention, also allows the multiplicity of data items to be evaluated for the first time, particularly in the case of processes with a multiplicity of participants and a multiplicity of process steps. The method therefore allows such processes to be speeded up and, if the method is used for automatic memory management for the purpose of archiving the structured data records interchanged as part of a process, for example, resources to be saved.

The implementation of the invention is not limited to the preferred exemplary embodiments indicated above. Rather, a number of variants are conceivable which make use of the apparatus according to the invention and the method according to the invention even in the case of embodiments of a fundamentally different nature.

### LIST OF REFERENCE SYMBOLS

1 Structured data record
11-20 Structured data records
2 Standardized part
3 Nonstandardized part
4 Process
100, 200, 300, 400 Computer system
110, 210, 310, 410 E-mail server
120 Database
130 Analysis device
131 Means for analysis
132 Means for classification
133 Means for evaluation
140 Output unit
150 Notification system
340 Web browser
K Purchaser
VK Vendor
MPB Marketplace operator
MPT Marketplace participant

1-29. (canceled)

30. A computer system for processing a structured data record, having
a communication device for retrieving and sending the structured data record,
a database device for storing the structured data record, and
an analysis device for processing the structured data record,
wherein the structured data record contains a number of characteristic information items arranged in an arbitrary manner in the structured data record, wherein
the analysis device has
means for automatically analyzing the characteristic information items contained in the structured data record,
means for automatically classifying the structured data record, which are able to be used to classify the structured data record into a class using the characteristic information items, and
means for automatically evaluating the structured data record classified into a class, which are able to be used to link the structured data record to other structured data records in the same or other classes using the characteristic information items.

31. The computer system for processing a structured data record as claimed in claim 30, wherein the computer system is an interface for evaluating structured data records between a second computer system, from which the structured data record
or a set of structured data records is retrieved, and a third computer system, to which the linked structured data records together with evaluated information describing a process are transmitted.

32. The computer system for processing a structured data record as claimed in claim 30, wherein the communication device is formed by an e-mail server, an FTP server or another device for transmitting electronic data.

33. The computer system for processing a structured data record as claimed in claim 30, wherein the analysis device has means for evaluating the linked structured data records.

34. The computer system for processing a structured data record as claimed in claim 30, wherein the computer system has an output unit for presenting the linked structured data records.

35. The computer system for processing a structured data record as claimed in claim 34, wherein the output unit is formed by a web server.

36. The computer system for processing a structured data record as claimed in claim 30, wherein the computer system has a notification system for notifying a user when an error ascertained using the linked structured data records occurs in a process represented by the linked structured data records.

37. The computer system for processing a structured data record as claimed in claim 36, wherein the notification system is formed by a telecommunication device for communication with a user.

38. A method for processing a structured data record, using a computer system as claimed in claim 30, in which the structured data record is retrieved, stored and processed, wherein the structured data record contains a number of characteristic information items arranged in an arbitrary manner in the structured data record, and wherein
the characteristic information items contained in the structured data record are recorded automatically,
the structured data record is automatically assigned to a class using the characteristic information items, and
the structured data record is automatically linked to other structured data records using the characteristic information items.

39. The method for processing a structured data record as claimed in claim 38, wherein the structured data record has a standardized structured part, which contains characteristic information items in a defined arrangement, and a nonstandardized structured part, which contains characteristic information items in an arbitrary arrangement.

40. The method for processing a structured data record as claimed in claim 38, wherein the structured data record is broken down into its standardized structured part and its nonstandardized structured part for the purpose of recording the characteristic information items contained in the structured data record.

41. The method for processing a structured data record as claimed in claim 40, wherein the characteristic information items contained in the standardized structured part and the nonstandardized structured part of the structured data record are evaluated separately.

42. The method for processing a structured data record as claimed in claim 38, wherein the structured data record is automatically assigned to a class, characterizing a process step in a process, using the characteristic information items.

43. The method for processing a structured data record as claimed in claim 38, wherein the structured data record is linked to other structured data records such that a cohesive data record structure in the form of a chain is obtained.

44. The method for processing a structured data record as claimed in claim 43, wherein the chains are branched chains.

45. The method for processing a structured data record as claimed in claim 38, wherein the linked structured data records represent at least one process which comprises one or more process steps.

46. The method for processing a structured data record as claimed in claim 38, wherein the linked structured data records and the characteristic information items contained in the structured data records are used to identify at least one process.

47. The method for processing a structured data record as claimed in claim 45, wherein the linked structured data records and the characteristic information items contained in the structured data records are used to evaluate the at least one process for the purpose of recording information describing the process.

48. The method for processing a structured data record as claimed in claim 47, wherein the evaluation of the process is taken as a basis for storing, erasing and/or for further processing the linked structured data records which represent the process.

49. The method for processing a structured data record as claimed in claim 45, wherein the linked structured data records and the characteristic information items contained in the structured data records are used to compare the at least one process with previously defined standard values.

50. The method for processing a structured data record as claimed in claim 45, wherein a process step to be performed subsequently is automatically identified.

51. The method for processing a structured data record as claimed in claim 45, wherein the linked structured data records and the characteristic information items contained in the structured data records are used to optimize the at least one process in terms of at least one optimization criterion.

52. The method for processing a structured data record as claimed in claim 51, wherein the process duration, the process speed and/or the process cycle are optimization criteria.

53. The method for processing a structured data record as claimed in claim 45, wherein the linked structured data records are used to ascertain errors or peculiarities in the at least one process.

54. The method for processing a structured data record as claimed in claim 45, wherein the linked structured data records are used to evaluate an individual process in terms of its specific features or to evaluate a multiplicity of processes in terms of their statistical features.

55. The method for processing a structured data record as claimed in claim 38, wherein the recorded characteristic information items are used to learn and store the structure of the structured data record.

56. The method for processing a structured data record as claimed in claim 38, wherein a structured data record which cannot be assigned to a class is assigned to an automatically freshly generated class.

57. The method for processing a structured data record as claimed in claim 38, wherein the linked structured data records which cannot be assigned to a process are assigned to an automatically freshly generated process.

58. A computer program for processing a structured data record from a set of structured data records, for the purpose of carrying out the method as claimed in claim 38.
